(19) United States
(12) Patent Application Publication
(10) Pub. No.: US 2015/0003224 A1
(43) Pub. Date: Jan. 1, 2015

(54) TESTING DEVICE AND METHOD THEREOF

(71) Applicants: HONG FU JIN PRECISION INDUSTRY (ShenZhen) CO., LTD, ShenZhen (CN); HON HAI PRECISION INDUSTRY CO., LTD., New Taipei (TW)

(72) Inventors: PENG-FEI WANG, Shenzhen (CN); DONG-YAN LI, Shenzhen (CN); BING ZHOU, Shenzhen (CN)

(21) Appl. No.: 14/315,860

(22) Filed: Jun. 26, 2014

(30) Foreign Application Priority Data
Jun. 28, 2013 (CN) 2013102683446

(51) Int. Cl. G11B 27/36

(52) U.S. Cl. CPC G11B 27/36
USPC 369/47.15

(57) ABSTRACT

A testing device in communication with a disc player includes a storage device and a display device. The storage stores a start command, an end command, and a reference value range of each of several performance parameters of the disc player. The start command is sent to the disc player a predetermined numbers times to obtain performance readings as the disc player reads data. The value of each performance reading of the disc player obtained each time the start command is transmitted is compared with a range of values preset for several performance parameters and the display device shows information indicating whether or not the disc player is acceptable.

### CROSS-REFERENCE TO RELATED APPLICATIONS

This application claims priority to Chinese Patent Application No. 201310268344.6 filed on Jun. 28, 2014, in the China Intellectual Property Office, the contents of which are incorporated by reference herein.

### FIELD

The present disclosure relates to a testing device for an optical disc player.

### BACKGROUND

Disc players include a casing and an optical pick-up head attached on the inside of the casing. The disc player can read data from a disc by using the optical pick-up head.

### BRIEF DESCRIPTION OF THE DRAWINGS

Implementations of the present disclosure will now be described, by way of example only, with reference to the attached figures, wherein:

FIG. 1 is a block diagram of an embodiment of a testing device.

FIG. 2 is a flowchart of an embodiment of a testing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

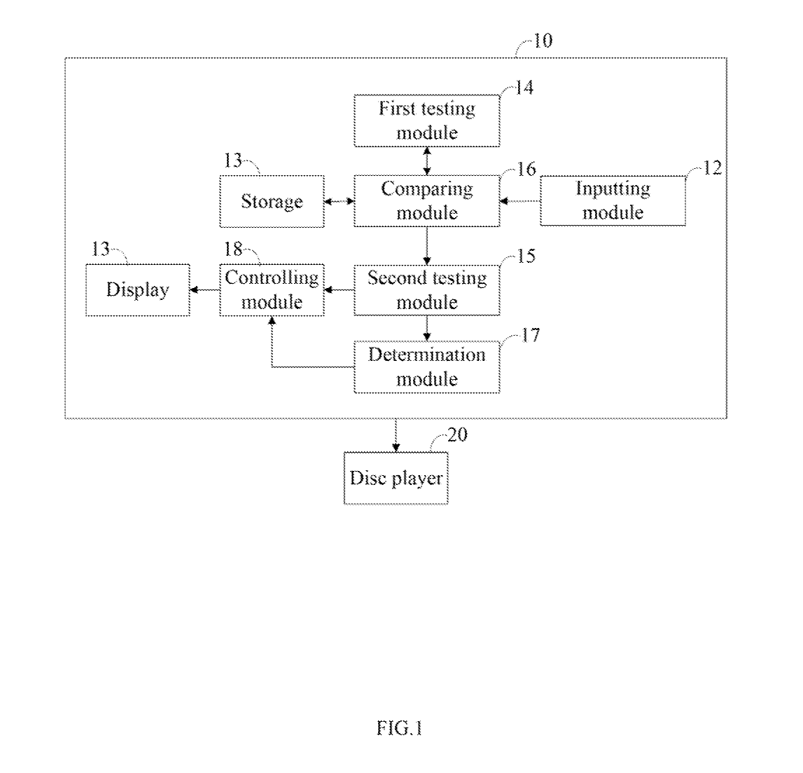

FIG. 1 illustrates an embodiment of a testing device 10. The testing device 10 can be configured to control a disc player 20 to execute a number of predetermined commands, for testing the disc player 20. The testing device 10 can be an independent device or a component integrated into the disc player 20.

The testing device 10 can include a storage 11, an inputting unit 12, a display 13, a first testing module 14, a comparing module 16, a second testing module 16, a determination module 17, and a controlling module 18.

The storage 11 can store a start command, an end command, and a reference value range of each of performance parameters of the disc player.

The inputting unit 12 can be a keyboard, a mouse, a touch screen, a touch pad, or a barcode scanner, for example, for receiving instructions.

The display 30 can be a liquid crystal display (LCD), a light emitting diode (LED) display, or other like display devices.

The first testing module 14 transmits the start command to the disc player 20 for controlling the disc player 20 to read data from a disc in the disc player. When the start command is successfully executed by the disc player, the disc player gives a response signal. The first testing module 14 determines whether the response signal of the start command is given by the disc player 20 within a predetermined time period. When the response signal of the start command is given by the disc player 20 within a predetermined time period, a value of each performance parameter of the disc player 20 can be obtained by the first testing module 14. When the response signal of the start command is not given by the disc player 20 within a predetermined time period, the controlling module 18 controls the display to display a first message indicating failure of an execution of the start command.

The second testing module 15 transmits an end command to the disc player 20 for controlling the disc player 20 to stop reading data from the disc when each of the performance parameters of the disc player 20 has been obtained. When the end command is successfully executed by the disc player, the disc player gives a response signal. The second testing module 15 determines whether a response signal of the end command is given by the disc player 20 within a predetermined time period. When the response signal of the end command is given by the disc player 20 within a predetermined time period, the second testing module 15 generates a comparing signal to the comparing module 16. When the response signal of the end command is not given by the disc player 20 within a predetermined time period, the controlling module 18 controls the display to display a second message indicating failure of an execution of the end command.

In response to the comparing signal being received, the comparing module 16 determines whether the start command has been given to the disc player a predetermined number of times, and triggers the first testing module to transmit a start command to the disc player if the start command has not been given to the disc player for the predetermined number of times In detail, the predetermined number of times can be manually input through the inputting unit 12.

The determination module 17 determines whether or not the disc player is deemed acceptable by determining whether the obtained value of each performance reading of the disc player is within the reference value range of a performance parameter each time that the start command is given. When the obtained value of each performance reading is within the reference value range of a corresponding performance parameter, the controlling module controls the display of the testing device to display a third message indicating that the performance of the disc player is acceptable. When the obtained value of each performance reading is not within the reference value range of a corresponding performance parameter, the controlling module controls the display of the testing device to display a fourth message indicating that the disc player is not acceptable.

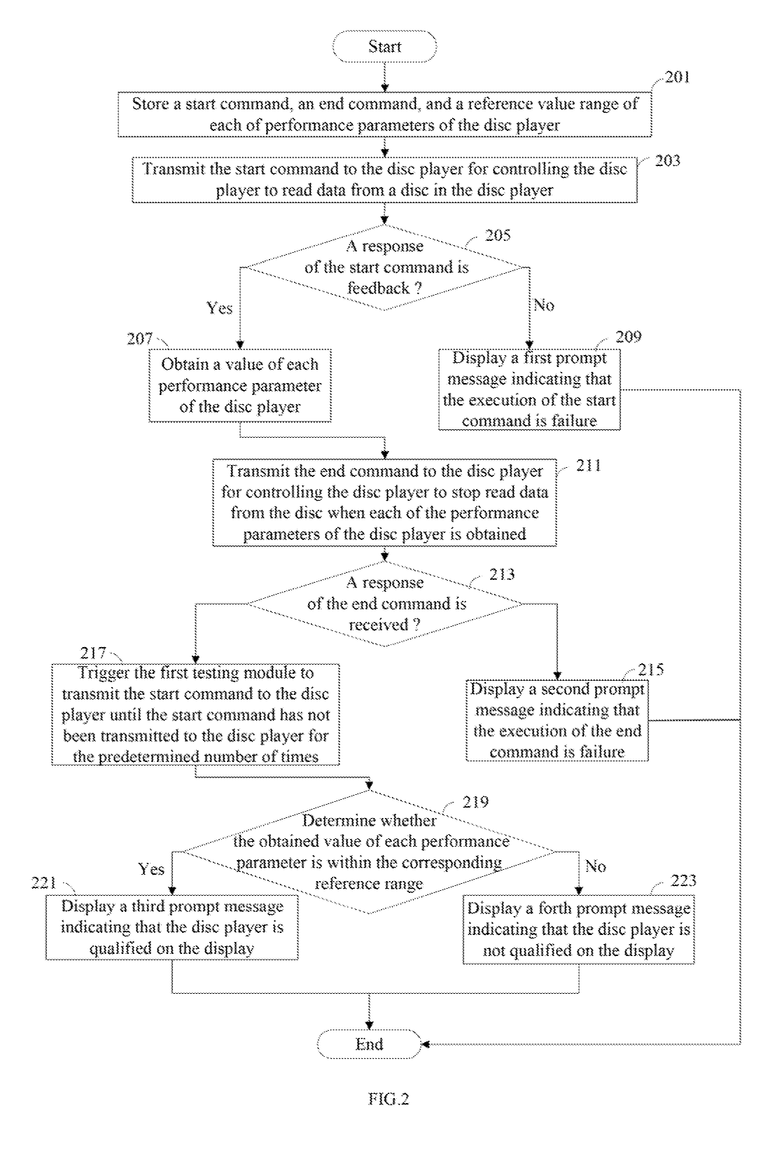

FIG. 2 illustrates a testing method implemented by a testing device to test a disc player. The testing device includes a storage, an inputting unit, a display, a first testing module, a comparing module, a second testing module, a determination module, and a control unit. Depending on the embodiment, additional steps may be added, others removed, and the ordering of the steps may be changed.

At block 201, the storage stores a start command, an end command, and a reference value range of each performance parameter of the disc player.

At block 203, the first testing module transmits the start command to the disc player for controlling the disc player to read data from a disc in the disc player.

At block 205, the first testing module determines whether a response signal of the start command is received from the disc player 20 within a predetermined time period. When the response signal of the start command is received from the disc player 20 within a predetermined time period, procedure goes to block 207. When the response signal of the start command is not received from the disc player 20 within a predetermined time period, procedure goes to block 209.

At block 207, the first testing module obtains a value of each performance reading taken from the disc player.

At block 209, the controlling module controls the display to display a first message indicating failure of the execution of the start command.

At block 211, the second testing module transmits the end command to the disc player for controlling the disc player to stop reading data from the disc when each of the performance readings of the disc player is obtained.

At block 213, the second testing module determines whether a response signal of the end command is received from the disc player within a predetermined time period. When the response signal of the end command is not received from the disc player within a predetermined time period, procedure goes to block 215. When the response signal of the end command is received from the disc player within a predetermined time period, procedure goes to block 217.

At block 215, the controlling module controls the display to display a second message indicating failure of the execution of the end command.

At block 217, the comparing module determines whether the start command has been transmitted to the disc player a predetermined number of times. If the start command has not been transmitted to the disc player for the predetermined number of times the comparing module triggers the first testing module to transmit the start command to the disc player. In detail, the predetermined number of times can be manually input through the inputting unit.

At block 219, the determination module determines whether the disc player is deemed acceptable by determining whether the obtained value of each performance reading of the disc player is within the reference value range of a corresponding performance parameter, every time that the start command is transmitted. When the obtained value of each performance reading of the disc player is within the reference value range of a corresponding performance parameter, the procedure goes to block 221. When the obtained value of each performance reading of the disc player is not within the reference value range of a corresponding performance parameter, procedure goes to block 223.

At block 221, the controlling module controls the display of the testing device to display a third message indicating that the disc player is acceptable.

At block 223, the controlling module controls the display of the testing device to display a fourth message indicating that the disc player is not acceptable.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A testing device connectable with a disc player having performance parameters, the testing device comprising:
a storage for storing a start command, an end command, and a reference value range corresponding to each of the performance parameters of the disc player;
a first testing module configured to transmit the start command to the disc player for controlling the disc player to read data from a disc in the disc player, and to obtain a value of each performance parameter of the disc player;
a second testing module configured to transmit the end command to the disc player for controlling the disc player to stop reading data from the disc when each of the performance parameters of the disc player is obtained;
a comparing module configured to determine whether the start command has been transmitted to the disc player a predetermined number of times, and to trigger the first testing module to transmit the start command to the disc player until the start command has been transmitted to the disc player for the predetermined number of times;
a determination module for determining whether the disc player is qualified by determining whether the obtained value of each performance parameter of the disc player is within the reference value range of the corresponding performance parameter at each time when the start command is transmitted;
a controlling module for controlling a display of the testing device to display a message indicating that the disc player is qualified or display a message indicating that the disc player is not qualified.

2. The testing device as claimed in claim 1, further comprising a setting module configured to set the predetermined number of times in response to a manual operation.

3. The testing device as claimed in claim 1, wherein when the obtained value of each performance parameter is within the reference value range of the corresponding performance parameter, the determination module further controls the display of the testing device to display a first prompt message indicating that the disc player is qualified.

4. The testing device as claimed in claim 1, wherein when the obtained value of each performance parameter is not within the reference value range of the corresponding performance parameter, the determination module further controls the display of the testing device to display a second prompt message indicating that the disc player is unqualified.

5. The testing device as claimed in claim 1, wherein the first testing module further determines whether a response signal of the start command is feedback from the disc player within a predetermined time period; if the response signal of the start command is not feedback from the disc player within a predetermined time period, the controlling module controls a display of the testing device to display a third prompt message indicating that an execution of the start command is failure.

6. The testing device as claimed in claim 1, wherein the second testing module further determines whether a response signal of the end command is feedback from the disc player within a predetermined time period; if the response signal of the end command is not feedback from the disc player within a predetermined time period, the controlling module controls a display of the testing device to display a forth message indicating that an execution of the end command is failure.

7. A testing method for testing a disc player having performance parameters using a testing device, the testing method comprising:
storing a start command, an end command, and a reference value range corresponding to each of the performance parameters of the disc player in a storage of the test device;
transmitting the start command to the disc player for controlling the disc player to read data from a disc in the disc player, and to obtain a value of each performance parameter of the disc player;
transmitting the end command to the disc player for controlling the disc player to stop reading data from the disc when each of the performance parameters of the disc player is obtained;
determining whether the start command has been transmitted to the disc player a predetermined number of times, and triggering the first testing module to transmit the start command to the disc player until the start command has been transmitted to the disc player for the predetermined number of times;
determining whether the disc player is qualified by determining whether the obtained value of each performance parameter of the disc player is within the reference value range of the corresponding performance parameter at each time when the start command is transmitted;
controlling a display of the testing device to display a message indicating that the disc player is qualified or display a message indicating that the disc player is not qualified.

8. The testing method as claimed in claim 7, further comprising:
setting the predetermined number of times in response to a manual operation.

9. The testing method as claimed in claim 7, further comprising: displaying a first prompt message indicating that the disc player is qualified when the obtained value of each performance parameter is within the reference value range of the corresponding performance parameter.

10. The testing method as claimed in claim 7, further comprising: displaying a second prompt message indicating that the disc player is unqualified when the obtained value of each performance parameter is not within the reference value range of the corresponding performance parameter.

11. The testing method as claimed in claim 7, further comprising:
determining whether a response signal of the start command is feedback from the disc player within a predetermined time period; and
displaying a third prompt message indicating that an execution of the start command is failure if the response signal of the start command is not feedback from the disc player within the predetermined time period.

12. The testing method as claimed in claim 7, further comprising:
determining whether a response signal of the end command is feedback from the disc player within a predetermined time period; and
displaying a forth message indicating that an execution of the end command is failure if the response signal of the end command is not feedback from the disc player within the predetermined time period.
